(19) United States
(12) Patent Application Publication
(10) Pub. No.: US 2004/0249897 A1
(43) Pub. Date: Dec. 9, 2004

(54) Method, system and apparatus for rejecting unauthorized or SPAM e-mail messages

(76) Inventor: Claudia Leticia Espinosa, Tampa, FL (US)

Correspondence Address: CLAUDIA L. ESPINOSA, 9205 PEBBLE CREEK DRIVE, TAMPA, FL, 33647, US

(21) Appl. No.: 10/859,669

(22) Filed: Jun. 3, 2004

Related U.S. Application Data
(60) Provisional application No. 60/476,938, filed on Jun. 9, 2003.

(51) Int. Cl. H04M 1/64; G06F 15/16

(52) U.S. Cl. 709/206

(57) ABSTRACT

A new method, system and apparatus of rejecting junk mail by using an access code that the sender inserts anywhere in the “SUBJECT” or “MESSAGE” sections of the e-mail message, and only those e-mail messages containing a valid access code previously defined by the owner of the destination e-mail are delivered. Successful senders are then added in a list of approved senders, so they do not need to add the access code in future messages. The messages without a valid access code are deleted and returned to the sender with instructions to include the access code in the SUBJECT or MESSAGE sections of the e-mail. If the access code is not known, the instructions ask the sender to access an Internet page to respond to personal questions about the e-mail owner. Only those senders that can answer to at least one of these questions correctly obtain the access code.

CROSS-REFERENCE TO RELATED APPLICATIONS

This is a non-provisional utility patent of U.S. application Ser. No. 60/476,938 filed Jun. 9, 2003.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Traditionally, bulk mail distributors and solicitors collect or buy lists of e-mail accounts from other individuals that are obtained mainly without permission or knowledge of the owner to send unsolicited and unwanted advertisement everyday, and it is often major the number of spam than the legitimate mail received.

Other common technique used by advertisers to send unsolicited e-mail is to create programs that generate sequential names for well known big e-mail providers and expect for valid hits after the millions of generated e-mail accounts. For example, they would create a program to send mail to aaa@domain.com, aab@domain.com, aac@domain.com, and so on, creating millions of combinations and selecting then the valid accounts not rejected to compile lists and send more advertisement.

The frustration increases when the final user does not seem to have an easy way to stop bulk companies from eventually knowing their e-mails addresses. Some advertisers add a link at the bottom, or a Reply-with-remove mechanisms to have an specific e-mail account deleted from their mailing lists, but this usually creates a bigger problem because when advertisers receive a mail back, they know that the account is active and the message was read, so they just keep using and selling the account to others with added value.

This entire problem has been growing uncontrolled and makes it difficult for the owner to select the legitimate mail from spam, and leaves a feeling of impotence, anger and frustration. An additional concern for parents is that many of the e-mail holders are children, and a big number of the spam mail has sexual content, links to pornography sites, scams, frauds, and eventually computer virus. In addition, current laws and legislation has proven to be not effective in controlling the problem especially for foreign spammers.

Many users have been changing their e-mail accounts from time to time after they receive too much spam, but this has a downside. Changing accounts often cause that friends, family or business contacts may not receive the new address, and therefore may lose contact with them. In the best of the cases, the persons who want to contact the owner again needs an alternate method to contact the owner to obtain the latest e-mail account and then update their book addresses for each one.

Other method that some people implement to avoid spammers is to open several accounts for specific uses. For example “shopping” e-mails used where it is more common to have the e-mail stolen, and just check it for new mail when there is a shopping in progress that needs to be tracked. With this method, the owner needs to keep several accounts and passwords, which implies additional log in, cleaning and revision times.

Other frequently used method is the development of e-mail filters (see U.S. Pat. No. 6,732,157) that scan the subject and message of incoming mails for specific words. Based on its match/no match result, the message is sent to an additional in-box to be reviewed later by the owner in case that some mail was not separated correctly. This method has some problems as well because there is always the risk of discarding a legitimate mail. An additional problem is that advertisers are using every time more common, diverse and friendly language that may be interpreted by filters as non-commercial e-mail and delivered in the “clean” in-box. A downside of this method and other similar is the extra time required by the user to review in-doubt boxes.

So far these and some other methods have not been able to effectively control unsolicited mail and have only reduced the problem at least in the non-commercial or corporative fields, leaving free or public-known providers dealing with a big problem and frustration for their customers.

### BRIEF SUMMARY OF THE INVENTION

The object of the invention is to create a service, a method, computer code and apparatus that rejects junk mail from legitimate mail by using an access code that the sender (FIG. 1.1) have to insert in the “SUBJECT” or “MESSAGE” sections of the e-mail message (FIG. 1.3), and only those messages containing this access code are delivered to the recipient (FIG. 1.9). Once a sender has successfully sent a message with the access code, his/her e-mail is added to an approved list of senders and the access code is not needed for future messages from the same sender.

The improvement of this method is the way to obtain the mentioned access code. When a mail is sent to the e-mail owner without the access code (FIG. 1.3), the message is deleted from the inbox and returned to the sender with instructions to access an Internet page (FIG. 1.5) that lets the sender obtain the code only if he/she knows personal key information of the owner (FIG. 1.8) like the first or last name, city where the person lives, zip code, hobby, pet name, etc.

Other improvement of this invention is that if the source e-mail is fictitious (invented or deleted after the message is sent) or it was sent by a solicitor or mass spam mail sender, the sender does not receive the reply requesting the access code (FIG. 2.4), or he/she is not be able to guess it, and he/she will not sent back the message to the recipient. The recipient will never even know that an unsolicited spam message was sent to his/her e-mail inbox (FIG. 2.5), liberating him/her of the extra time and effort of reading and classifying these messages or checking extra in-doubt mailboxes.

### BRIEF DESCRIPTION OF THE SEVERAL VIEWS OF THE DRAWING

FIG. 1 shows the order of actions when a sender(1) with a real e-mail sends an e-mail message to a recipient(9), and when the sender is not in the approved list of senders(9) or the e-mail message is sent without an access code or with an invalid access code, the sender(1) receives the e-mail message back with instructions to insert or obtain the access code(4, 5, 6, 7, 8).

FIG. 2 shows the order of actions when a sender(1) with an invented, fictitious or deleted e-mail(4) sends a message to the recipient without the access code or with an invalid access code(3). The sender does not receive back the instructions to obtain the access code and the original e-mail and any errors about the same e-mail are ignored(5, 2) and the recipient(6) never knows that he had this e-mail sent to his mailbox.

### DETAILED DESCRIPTION OF THE INVENTION

The main problem is that advertisers and spam senders only need to know the e-mail address to send a message, so the invention creates a service, a method, computer code and apparatus to offer e-mail services to customers or users that when registering they need to enter as part of their regular information such as first name, last name, access password, address, etc, an additional e-mail access code. It is also suggested that the created e-mail address be a pseudonym that does not reveal any real information about the user. In other words, it should not contain full or sub strings parts of the first name, last name, address, profession, etc. The reason is explained in the next paragraphs.

The e-mail access code can be any word, nick name or number. It is suggested that it does not exist in dictionaries and contains some numbers or special characters, so it will be difficult to guess by spammers.

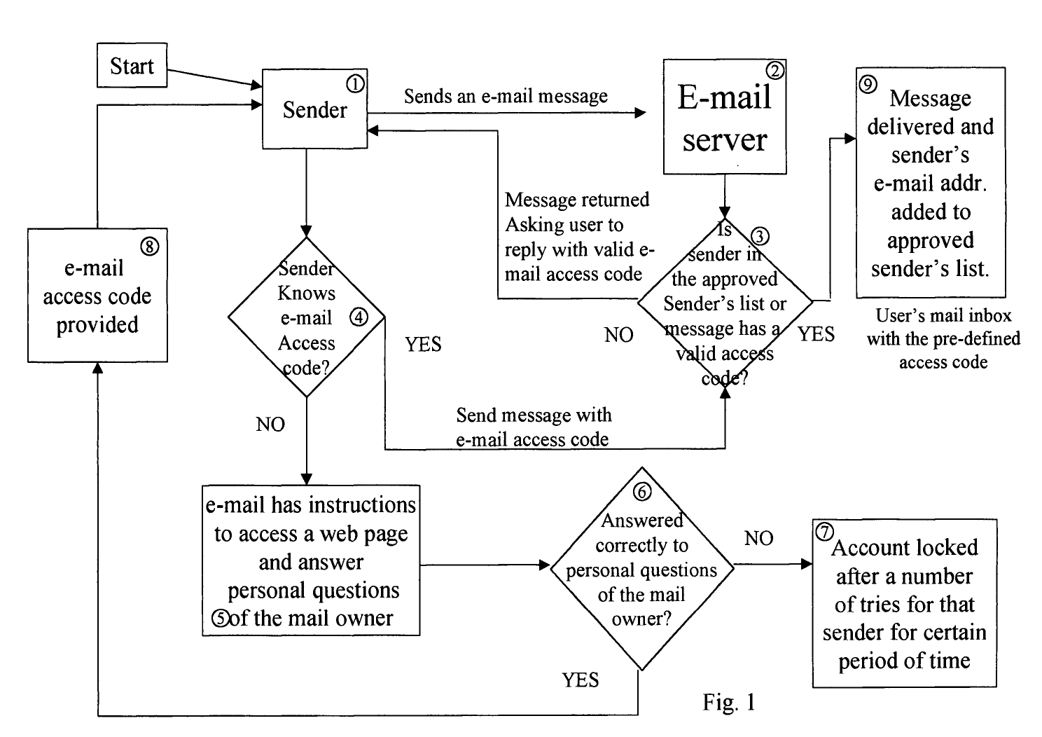

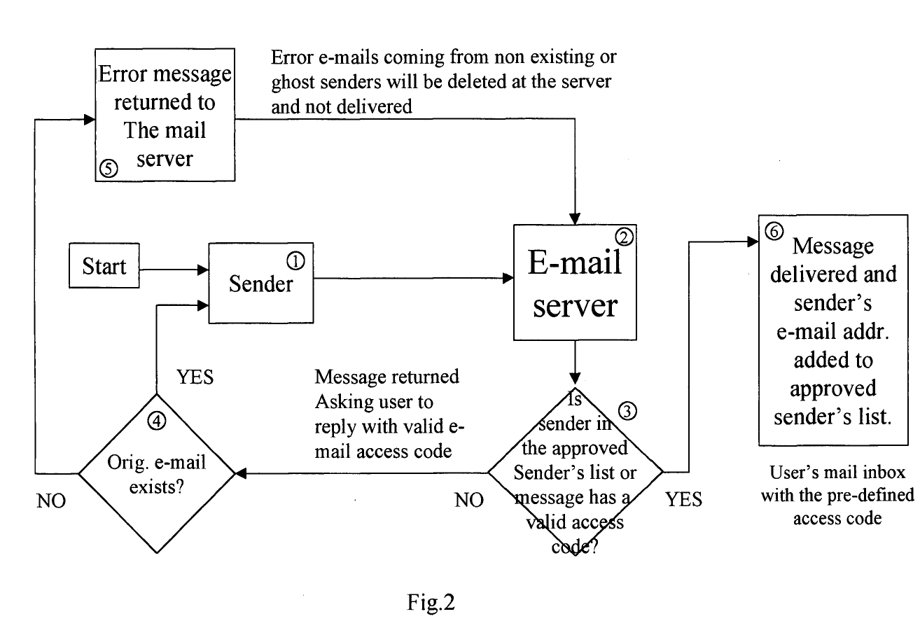

Once the account and the e-mail access code are created and an e-mail is received, the mail server checks inside the SUBJECT and MESSAGE sections of the e-mail for the valid access code; if it is present either in the SUBJECT or anywhere in the MESSAGE, the e-mail is accepted, otherwise, the message is not be delivered, but returned to the sender with instructions in several languages, indicating that in order to deliver the message, the sender has to reply with an access code inserted in the SUBJECT or MESSAGE fields (FIG. 1). If the sender e-mail is a ghost or invented account, or the sender's e-mail was deleted after the original message was sent (common practice of spammers and solicitors), the reply message would not find the reply mailbox and these error messages are ignored all together (FIG. 2). When the sender's mailbox is real, the sender must read and follow the instructions in the reply message in order to make the message reach the recipient as described in the next paragraph.

The action required from the sender if the access code is known is to reply to the message and insert the access code in the SUBJECT or MESSAGE sections, otherwise, the sender must follow the instructions in the same mail to obtain the access code by accessing a web page built dynamically for the specific e-mail owner. The sender then has to enter key information of the recipient to obtain the mentioned access code such as first name, last name, city where the person lives, school, zip code, hobby, etc (either one, not all). In this way, only those senders who really know the e-mail owner will know the correct answers, and can get the e-mail access code after answering correctly to at least one of the questions. After obtaining the e-mail access code, the sender only has to reply to the rejected message (since it has the owners e-mail address in the From field) and add the e-mail access code to the SUBJECT or MESSAGE sections, and the message will be delivered the second time (FIG. 1).

When created, it is suggested that the e-mail be a pseudonym and do not contain revealing information about the owner's identity or information that will reveal the answer to the questions to obtain the access code. This does not represent a major problem since outside the corporative environment e-mail accounts are most of the time pseudonyms anyway. For situations where real names are needed as part of the e-mail account, especially in business, the e-mail access code can be name of a city, zip code, building location, profession, department, etc.

An additional protection mechanism at the server is to disable the screen to obtain e-mail access code for the specific accounts for several minutes or hours after a limited number of tries to obtain the e-mail access code unsuccessfully, so it can protect the access for sequentially generated fields with computers. Additional server protection can block specific IP addresses for recurring tries from the client, and encryption the fields of the mentioned screen which is standard when sending secure sensitive information thorough public networks.

The e-mail owner also has access through web pages to statistics of persons trying to gain access to his/her e-mail access code, and eventually they are able to contact them if they unsuccessfully tried to obtain the e-mail access code but are wanted contacts. Those senders unable to obtain the access code have the option to leave their name and e-mail for further contact.

In the case of advertisers, solicitors or spammers ever steal the e-mail access code, and the e-mail owner starts receiving spam or junk mail, he/she only has to log in to his/her account with his/her user (usually the e-mail account) and the account password, and change the e-mail access code for a new one. New senders who know personal information about the e-mail owner can obtain the new e-mail access code again in just few minutes. As a logical conclusion, a user will never have to change his/her e-mail account. The same e-mail account can be used for life as long as the e-mail service provider is in business.

Additionally and even though not needed to make this invention works, this additional improvement increase the security and management of e-mail access codes, so when the e-mail owner wants to send mail from his account, additional fields to the commonly found in e-mail applications (From, To, Cc, Bcc, Subject and Text Body or message) named “e-mail access code” can be created, and the code entered in this field is automatically added to the end of the message when sending the e-mail. Eventually, if this invention becomes a standard in the industry, the field would be a completely separated field and encrypted for protection using methods like SSL or similar encryption tools and also sent to other mail servers as a separate field to be received and handled as such. It can also and eventually be added to Electronic Book Address applications as a new field.

Once a message with the valid access code has been delivered to the recipient, the sender's e-mail is added to an approved e-mail addresses list (this can function also as an address book), so those senders do not have to include the access code again when they send new messages. The e-mail owner have also the choice of deleting or adding e-mail addresses manually to this list of approved senders, and he/she has the option to add generic senders for a specific domains. For example, an entry like *@xycmail.com will allow the owner to receive mail from sales@xycmail.com or custserv@xycmail.com

An example of an access code could be ABXYZ12.

An example of the access code inserted in the SUBJECT field can be the following:

“Regards from your friends in Hawaii ABXYZ12”

An example of the access code inserted in the SUBJECT field is (can be anywhere in the message):

Hello John.

We hope you are fine. Say hello to your wife.

Regards

ABXYZ12

In other patented methods I found in my research, the messages which do not have this e-mail access code are transferred to an in-doubt or alternate in-box to be reviewed by the user later on and decide if they are good or not. It requires additional time and effort from the user to select valid messages from spam and unsolicited advertisement.

The big improvement of this compared to current methods is that when a message is rejected, no further action is needed from the e-mail owner; it only requires action from the original sender. An additional benefit is that when the mail is sent from ghost users or not valid actual and existing e-mail accounts, the message requesting a reply with the e-mail access code is not be delivered to anyone, and nobody replies either to the message or try to find the e-mail access code, so it is completely transparent for the user and he/she never knows that junk mail was sent to his/her account. All error messages returned from the reply to ghost accounts are automatically eliminated as well, and they never reach the clean inbox.

Other improvement is that the e-mail owner has access to review only the e-mails and IP addresses of persons who tried to obtain his/her e-mail access code, and not all persons who unsuccessfully sent him/her mail, making the list to review very short, or shorter than with current filtering methods.

Other benefit for server owners and e-mail services providers is that since senders need to know personal information about the e-mail owner, it would be likely that persons opening new accounts will provide real and current data when registering, instead of fake or invented information.

One final advantage is that any regular currently existing application or new development can be used to send mail under this improved method because the e-mail access code is inserted in the SUBJECT or MESSAGE fields, and those are currently found in any mail management system. The Owner of an e-mail is able to send mail to anybody he/she wants to in a regular way having also the option of adding the e-mail access code the outgoing e-mail. For existing e-mail or address-book applications with out a field specifically created to store the e-mail access codes, they can be stored together as part of a standard header or footer, so they are added when a new e-mail is created.

1. What I claim as my invention is the method, system and apparatus requesting or modifying the necessary information from a person to create and maintain an e-mail account such as an e-mail pseudonym, name, address, age, plus an access code containing letters and/or numbers as well as several personal questions about the identity of the e-mail owner and the correct answers that are stored in a database accessible to the mail server as part of the e-mail owner's account profile (FIG. 1.9), and a method, system and apparatus for handling and rejecting spam or unsolicited advertisement and bulk e-mail messages from reaching the mailbox of the owner based on an access code inserted by the sender anywhere the SUBJECT or MESSAGE sections of the e-mail message and the method for obtaining the mentioned access code if the sender does not have it (FIGS. 1.3, 1.4, 1.5, 1.6, 1.7 and 1.8).

2. The method, system and apparatus wherein the mail server receives an incoming e-mail message (FIG. 1.2) and checks for the sender's e-mail address in a list of approved senders for that mailbox (FIG. 1.3), and if it is found, it delivers the message to the destination e-mail owner's inbox (FIG. 1.9).

3. The method, system and apparatus wherein the mail server (FIG. 1.2) receives an incoming e-mail message and does not find the e-mail address of the sender in the list of approved senders (FIG. 1.9) and then it further tries to find a match between the owner's defined access code explained in claim 1 and the access code in the SUBJECT or MESSAGE fields of the incoming e-mail message (FIG. 1.3), and when there is a positive match, the mail server (FIG. 1.2) delivers the mentioned message to the destination e-mail owner's inbox (FIG. 1.9), and if the e-mail address of the sender is not in the stored list of approved senders for that mailbox, it is added to the mentioned list automatically.

4. The method, system and apparatus wherein the mail server (FIG. 1.2) receives an incoming e-mail message and does not find the e-mail address of the sender in the list of approved senders and there is not a positive match between the access code in the SUBJECT or MESSAGE sections of the e-mail and the owner's defined access code explained in claim 1 (FIG. 1.3), then the message is sent back to the sender (FIG. 1.1) with the explanation of why the message is not being delivered and request the sender to access an HTML web page (FIG. 1.5) where the questions defined by the e-mail owner are displayed as explained in claim 1.

5. The method of claim 4 wherein the sender accesses the HTML web page indicated in the instructions (FIG. 1.5) and answers correctly to at least one of the questions defined by the e-mail owner (FIG. 1.6) and the pass code is delivered in a subsequent screen (FIG. 1.8).

6. The method of claim 4 wherein the sender (FIG. 1.1) reply to the rejected message and inserts the known or obtained access code anywhere in the SUBJECT or MESSAGE sections of the e-mail (FIG. 1.4) and sends the message again.

7. The method of claim 4 wherein the HTML web page to obtain the access code (FIG. 1.5) is disabled for the sender's IP address for a predefined length of time, after the sender fails to answer correctly at least one of the questions defined by the e-mail owner after a predefined number of tries, which means that the sender does not know the sender personally, and it is probably a bulk mail or spammer who purchased the e-mail or obtained it indirectly (FIG. 1.7).

8. The method of claim 4 wherein the senders e-mail address (FIG. 2.1) is invented, non-existent or was deleted after the original mail was sent and the rejected message (FIG. 2.3) does not find a real e-mail address to deliver the instructions on how to obtain the access code (FIG. 2.4 and 2.5).

9. The method of claim 8 further creates an error message (FIG. 2.5) in the mail server (FIG. 2.2) indicating that the rejected mail with the instructions to obtain the access code could not be delivered to a valid mailbox, and then the same mail server deletes this error message so it never reaches the owner's mailbox (FIG. 2.6).

10. The method, system and apparatus of claim 1 wherein allowing the e-mail owner to disable, delete, update or change its access code and the personal questions and its correct answers.

11. The method, system and apparatus of claim 1 wherein the e-mail owner can see statistics of attempts to obtain the access code and information left from senders unable to obtain the access code.

12. The method, system and apparatus of claim 1 wherein allowing the e-mail owner to manually add, delete or change the table of approved senders and also the possibility to add generic senders of a specific domain, for example: an entry like *@abcmail.com allows the e-mail owner to receive e-mails from any sender registered in the @abcmail.com domain.

13. The method, system and apparatus wherein improving the format of the Simple Mail Transfer Protocol (SMTP) to include an additional field called ACCESS-CODE to the already existing fields: TO, FROM, CC, BCC, SUBJECT, MESSAGE, MIME extensions and ATTACHMENT.
